(19) United States
(12) Patent Application Publication
(10) Pub. No.: US 2005/0279287 A1
(43) Pub. Date: Dec. 22, 2005

(54) Water container in combination with a water level alerting apparatus

(76) Inventor: Randall W. Kroeker, Ottawa (CA)

Correspondence Address: J. GORDON THOMSON, 1353 MOUNTAINSIDE CRESCENT, OTTAWA, ON, K1E 3G5, CA

(21) Appl. No.: 11/139,577

(22) Filed: May 31, 2005

(30) Foreign Application Priority Data
Jun. 17, 2004 (CA) 2476304

(51) Int. Cl. A01K 7/02

(52) U.S. Cl. 119/72

(57) ABSTRACT

A water container in combination with a water level alerting apparatus comprises a receptacle for containing a suitable amount of water having a high and a low water trip point. A water level detection probe is co-located at each trip point. The probe sends an analogue signal to an integrated circuit where the signal is converted to a digital signal and amplified. The amplified signal triggers a human detectable alarm. The probe is either a conductive metal rod penetrating the receptacle side wall or a metallic strip encircling the exterior of the side wall. The device is operated by an integral DC power source such as a battery.

### RELATED APPLICATIONS

This invention claims the benefit of Canadian Patent Application 2,467,364 “Low Water Alerting Apparatus” filed in the Canadian Patent Office on Jun. 17, 2004 by Randall W. Kroeker.

### BACKGROUND OF THE INVENTION

The present invention relates to water containers and more particularly water containers that are combined with water level alerting apparatus.

Water containers such as dishes for pet drinking water are well known commercially. Unattended, these water containers can easily go dry. The result is animal distress. Some inventions have attempted to overcome this problem by providing an “automatic watering” container wherein the drinking disk is replenished automatically from a connected container. However, such devices are cumbersome, expensive and can result in overfilling of the bowl. Other devices have been developed to alert the human care giver when the drinking dish is low on water. Once such device is illustrated in U.S. Pat. No. 6,318,291 “Pet bowl with means to notify a pet owner that the food or drinking bowl is empty” issued to Wolanski on Nov. 20, 2001. This device relies upon pressure sensors to detect a low water or food condition in the water dish. Such detection methods are unreliable because anything in the bowl will cause the pressure sensor to detect a filled condition. For example, an animal's toy could be placed in the food bowl or water dish by the animal and cause a low food or water condition to go undetected. Therefore, there is a need for a more reliable method of detecting a low water condition in a drinking water dish or other similar water container.

### SUMMARY OF THE INVENTION

A principal object of the present invention is the provision of an improved water container combined with a low water level alarm.

Another object of the present invention is the provision of an improved water container combined with a low water level alarm and a high water level alarm that is easy to manufacture and operate.

Still another object of the invention is to provide a more reliable means of detecting a low water condition in a drinking dish or other similar container for holding water.

The above and other objects of the present invention will become apparent from a reading of the following description taken in conjunction with the accompanying drawings which illustrate the preferred embodiments thereof.

A water container in combination with a water level alerting apparatus is provided. The combination comprises a receptacle for containing a suitable amount of water. The receptacle has at least one predetermined water level alarm trip point; means for detecting the at least one water level alarm trip point; means for converting the detection of the at least one water level alarm trip point into an electronic signal and means for converting the electronic signal into a human detectable alarm such as an audible alarm or a visual alarm. One embodiment of the invention includes a low water level alarm trip point. Another embodiment of the invention includes both a low water level alarm trip point and a high water level alarm trip point to avoid overfilling of the receptacle. Generally, the receptacle has a bottom and a sidewall forming a water container. The sidewall has a predetermined height and a predetermined thickness and is sufficiently high so that the container contains a predetermined volume of water. The low and high water level alarm trip points are located a predetermined distance above the receptacle bottom.

The detection device includes at least one conductive probe penetrating the sidewall of the receptacle into the container at the low and high water level alarm trip points where both are provided. The probe is adapted to detect aqueous fluids. The probe can be a metal rod having a first wet condition and a second dry condition. Where the receptacle is metallic, the probe is insulated from the sidewall of the receptacle. The probe is adapted to provide a capacitance transient signal as the probe moves from a wet to a dry condition. The alarm circuitry includes a capacitor connected between the conductive probe an integrated circuit that acts as an analogue to digital converter and an amplifier. A DC power source is also provided for energizing the circuit and the alarm devices. The invention successfully operates using the QT114 Charge Transfer QLevel™ sensor manufactured and sold by QProx™. The audible alarm may have adjustable volume control and adjustable modulation. The visual alarm may also comprise at least one light emitting diode that may blink or flash. The power source may comprise a battery rechargeable by connection with an AC power source or a photovoltaic panel.

### BRIEF DESCRIPTION OF DRAWINGS

FIG. 1 is a cross-sectional side view showing one embodiment of the invention, namely, a cylindrical container in combination with a low water level alarm apparatus.

FIG. 2 is a cross-sectional side view showing another embodiment of the invention, namely, a water dish in combination with a low water level alarm apparatus.

FIG. 3 is a cross-section side view showing another embodiment of the invention, namely, a metallic water dish in combination with a low water level alarm apparatus having a ground.

FIG. 4 is a cross-sectional side view showing yet another embodiment of the invention, namely, a water dish having the visual alarm placement relatively flush with the outside wall of the dish.

FIG. 5 is a schematic of the relationship of the various electronic components of a single probe embodiment of the invention.

FIG. 6 is a cross-sectional side view of another embodiment of the invention, namely, a cylindrical container having a low level alarm and a high level alarm.

FIG. 7 is a schematic of the relationship of the various electronic components of a dual probe embodiment of the invention.

FIG. 8 illustrates one embodiment of the invention wherein the digital output is converted into a wireless signal.

FIG. 9 shows three additional embodiments of the invention wherein various power sources are possible, namely, AC converted to DC, AC charging a DC battery and DC photovoltaic charging a DC battery.

FIG. 10 shows the sensor inputs and outputs of one embodiment of the invention.

FIG. 11 shows the sensor inputs and outputs of another embodiment of the invention.

### DETAILED DESCRIPTION OF THE PREFERRED EMBODIMENTS

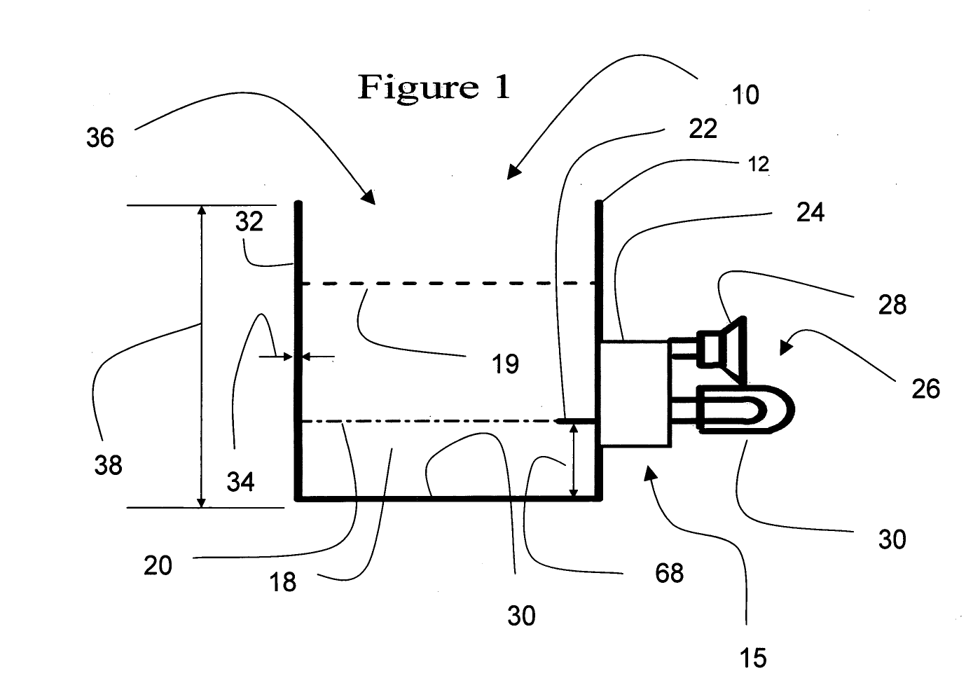

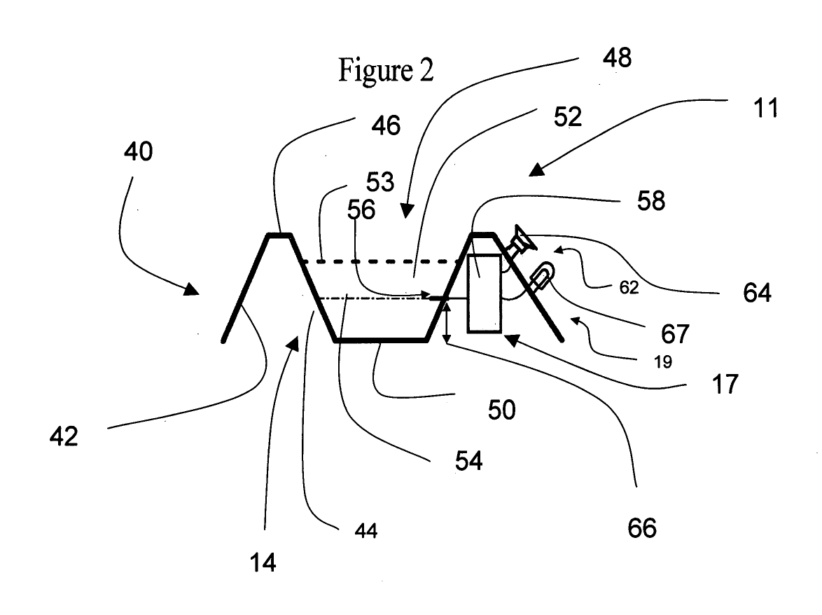

One embodiment of the invention is a water container in combination with a low water level alerting apparatus. The water container may take a variety of shapes and have a plurality of applications. For example, FIG. 1 illustrates a sectional side view of one embodiment of the invention (10). In this embodiment, the receptacle (12) is cylindrical in shape as might be found in a Christmas tree holder. The alerting apparatus (15) is exterior to the receptacle. Being able to detect low water conditions in such a container is extremely important to avoid the tree drying out and becoming a fire hazard. Another embodiment of the invention (11) is shown in FIG. 2. This embodiment represents a receptacle (14) having the shape of a common metallic dog water dish. The low water level alerting apparatus (17) is located within the receptacle body (19). For the comfort and health of the animal, it is important that the water level in the dish be able to be automatically monitored and any low water condition be relayed in some human detectable way to the care giver. Understandably, the receptacle can take any shape and have any application where the monitoring of water level is important. Examples include aquariums, large wet batteries, cooking pots, water coolers, hot tubs and bathing tubs.

Referring now to FIG. 1, the illustrated embodiment of my invention (10) comprises a receptacle (12) for containing a suitable amount of water (18) forming a high water mark (19). The receptacle has a predetermined low water level alarm trip point (20). Combined with the receptacle is a low water level alerting apparatus generally shown as (15). The low water level alerting apparatus comprises means (22) for detecting the low water level alarm trip point, means (24) for converting the detection of a low water level alarm trip point into an electronic signal and means (26) for converting the electronic signal into a human detectable alarm (28) in the case of an audible alarm and (30) in the case of a visual alarm.

In FIG. 1, the receptacle (12) has a bottom (30) and a sidewall (32) having a thickness (34) surrounding the bottom. This forms the container (36). The sidewall (32) has a predetermined height (38). Height (38) is sufficient to allow the container to contain a suitable volume of water.

Referring to FIG. 2, there is illustrated another embodiment of my invention (11) comprising a receptacle (14) that is dish-shaped. The receptacle has a frusto-conical rim (40) with sloping outside and inside walls (42) and (44) respectively and top surface (46). The receptacle forms container (48) that is concave shaped. In this illustration the bottom (50) of the container is illustrated as flat, but it may also be rounded as is often found in dog water dishes. Within the container is a predetermined volume of water (52) having a high water mark (53). A low level alarm trip set point is established as (54). The low water level alerting apparatus (17) of this embodiment is located under the rim (40) of the receptacle. Means (56) for detecting the low water level alarm trip point, means (58) for converting the detection of a low water level alarm trip point into an electronic signal and means (62) for converting the electronic signal into a human detectable alarm in the case of an audible alarm (64) and in the case of a visual alarm (67) are included in this embodiment of the invention.

In FIGS. 1 and 2, the low water level alarm trip points (20) and (54) are located at a predetermined distance (66) and (68) above the receptacle bottoms (30) and (50) to ensure that the low level alarm is triggered before the container runs dry.

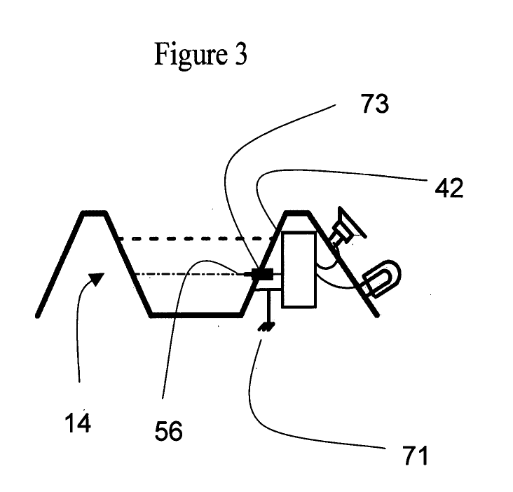

The receptacle of the embodiment shown in FIG. 2 may be plastic or some other non-conductive material. However, if the material is conductive then it is necessary to provide a path to ground (71) as illustrated schematically in FIG. 3 and provide an insulator (73) between the detector means (56) and the wall (42) of the receptacle (14). This would be necessary for all receptacles made of conducting material.

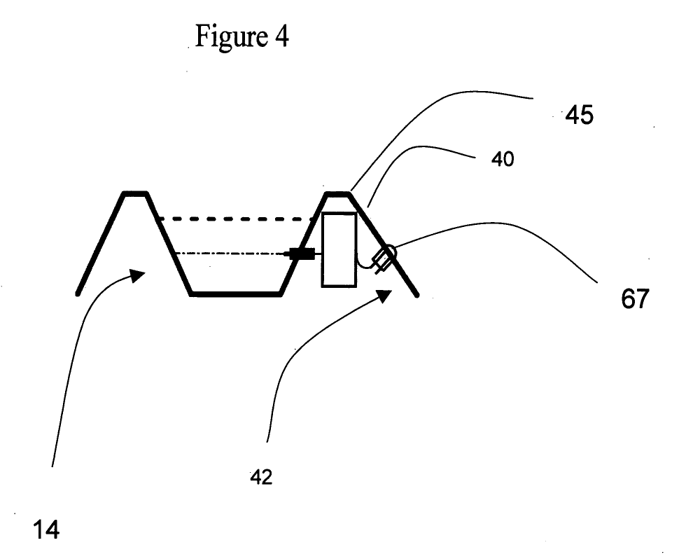

Referring to FIG. 4, it is desirable to have a smooth outside surface (45) to the outer wall (42) of the embodiment shown and therefore, as an example, the visual alarm (67) is mounted inside the rim (40) of the receptacle (14) so that it is relatively flush with the outside surface.

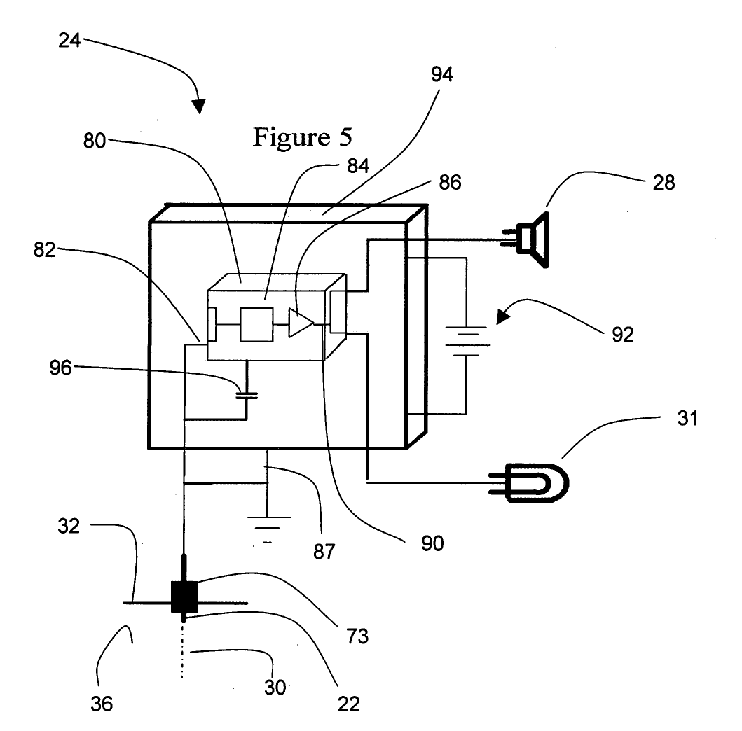

Referring now to FIG. 5, there is shown, as an example, apparatus (24) from the embodiment shown in FIG. 1, for detection of a low water level alarm trip point in a container. The apparatus includes low water level detection means (22) comprising at least one detecting probe penetrating the sidewall (32) in FIG. 1 of the receptacle into the container (36) at the low water level alarm trip point (30). The least one detecting probe (22) is a conductive probe adapted for detecting conducting aqueous fluids such as water and measuring capacitance between a wet and dry condition. The probe is adapted to detect aqueous fluids. The conductive probe is a generally a metal rod having a first wet condition when immersed within a container and a second partially dry condition when the low level alarm trip point has been reached at about the mid-line of the probe. The metal rod probe is insulated by insulating means (73) such as rubber, plastic or other non-conductive material from the sidewall if the sidewall is metallic. The metal rod has a sufficient area exposed to the liquid to create a rapid transitive capacitive step between the wet condition and dry condition of the probe at the alarm trip point. Other types of probes may be used with the invention including conducting strips that are able to produce the required signal.

Still referring to FIG. 5, there is shown a schematic diagram of the means for converting the signal from the probe into an electrical output for triggering an audible or visual alarm. Means for converting the capacitive transient into an electronic signal comprises an integrated circuit (80) comprising at least one analogue input (82) to receive a signal from the probe, an analogue to digital converter (84), an amplifier (86) and at least one digital output (90). A DC power source (92) is connected to the mother board (94) to energize the integrated circuit and the audible (28) and visual (31) alarms. There is located between the probe (22) and the integrated circuit (80) a capacitor (96) adapted to block DC current flows into the probe. Ground (87) provides a ground to the motherboard (84).

In operation, the analogue signal is received from the probe (22) at the low level alarm trip point (30) as a change in capacitance between a wet condition and a dry condition. The signal is then converted by the analogue to digital converter (84) into a digital signal. The digital signal is amplified by amplifier (86) and used to drive the audible (28) or visual alarm (31) device. In another embodiment of the invention, the audible alarm device (28) is a self-driven peizo alarm. In still another embodiment of the invention, the audible alarm device (28) has a volume control. In one embodiment of the invention, the audible alarm can be programmed to emit a modulated sound. In yet another embodiment of the invention, the visual alarm (31) is a red light emitting diode.

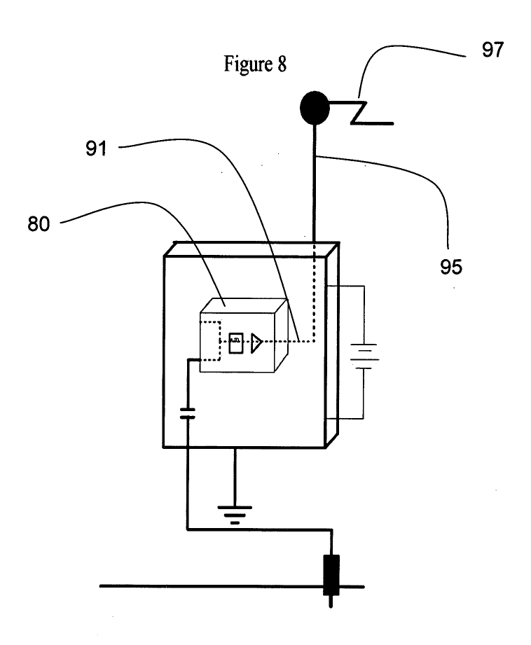

Referring to FIG. 8, and in still another embodiment of the invention, the integrated circuit (80) digital output (91) could be used to drive a wireless signal generator (95) to generate a transmittable signal (97) for wireless capture by a remote alarm system.

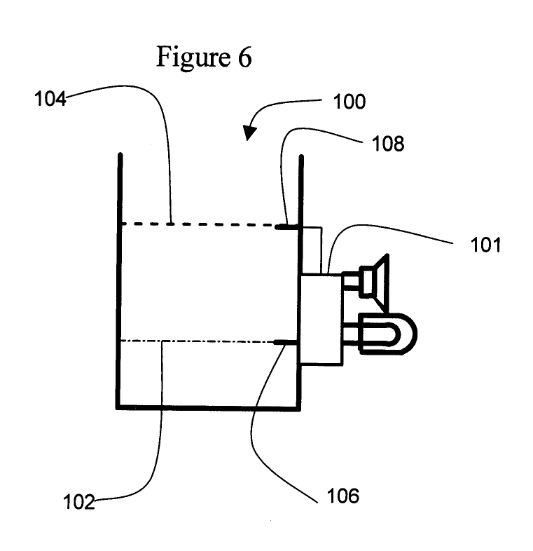

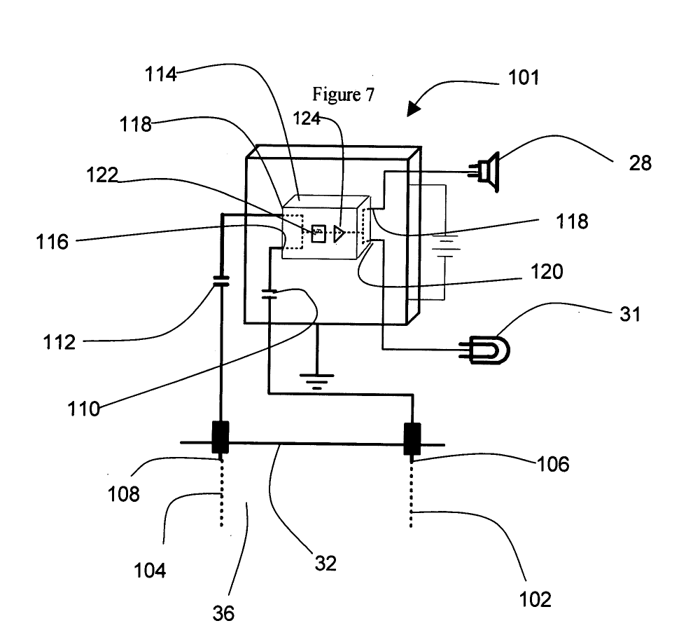

Referring now to FIGS. 6 and 7, there is shown yet another embodiment of the invention, (100) where the alarming apparatus (101) has both a low water level alarm trip point (102) and a high water level alarm trip point (104) to prevent overflow. Such a configuration would be well suited to visually impaired persons. There is a low water level detector in the form of a probe (106) and a high water level detector in the form of a probe (108). These probes may be of the strip type or the metal rod type as previously described with the latter type requiring insulation from any metallic body.

FIG. 7 represents a schematic of the alarm device (101) used with a two probe system. Each of the probes (106) and (108) penetrate the side wall (32) of the container (36). A capacitor (110) and (112) is installed between each probe and the integrated circuit (114). The integrated circuit is of the same type as previously described and has inputs (116) and (118) to accept two probes and outputs (118) and (120) to drive audible and visual alarm devices (28) and (31) respectively. The integrated circuit also contains an analogue to digital converter (122) and an amplifier (124).

One type of integrated circuit design successfully used in the invention for both single probe and dual probe operation is the QT114 Charge Transfer QLevel™ sensor manufactured and sold by QProx™. This device is generally powered by a DC power source such as a battery. The battery is generally a button type battery adapted to produce the correct voltage for the integrated circuit.

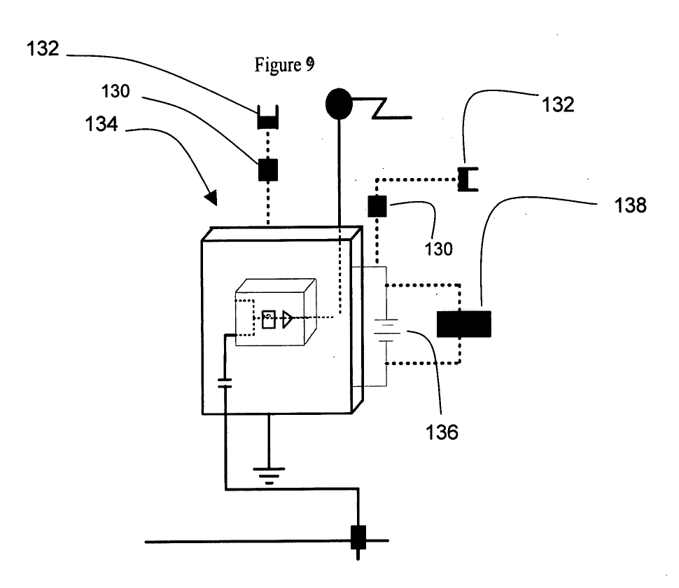

Referring to FIG. 9, there are other embodiments of the invention wherein the alarm apparatus includes a transformer (130) to transform 110VAC household voltage (132) into the required DC voltage to operate the apparatus (134). In yet another embodiment of the invention, the device may utilize re-chargeable batteries (136) that may be periodically recharged using 110VAC household current (132) through a transformer (130). In still another embodiment of the invention, the apparatus may rely upon DC photovoltaic panels (138) to charge batteries (136).

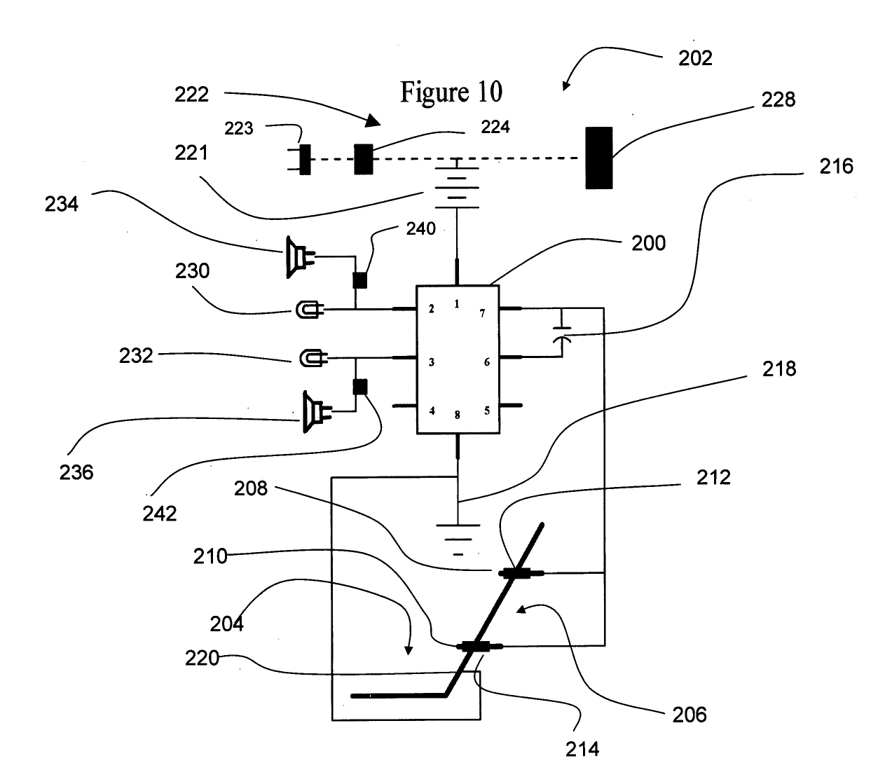

Referring to FIG. 10, there is shown the relationship between the integrated circuit (200) and the other components of the alarm apparatus (202). The water (204) is contained within a receptacle (206). This embodiment shows both a high water level detection probe (208) and a low water level detection probe (210). The receptacle (206) of the illustrated embodiment is metallic and therefore the probes are insulated by insulators (212) and (214). Water moving across either probe will cause a capacitive transient detectable by the integrated circuit (200). Capacitor (216) acts to impede the flow of DC current into the probes. The probes are connected to analogue input (7) and the capacitor is connected to analogue input (6) of the integrated circuit (200). In this embodiment, the integrated circuit (200) is grounded at (218). The metallic receptacle (206) is also grounded at point (220) connected to ground (218). The system is energized by a DC source (222) having an input at (1). The DC source may be batteries (221), DC household current (223) transformed to DC voltage by a transformer (224) or photovoltaic cells (228) connected to the batteries. Within the integrated circuit the analogue inputs from the probes are converted to digital signals and amplified. The digital signals are used to drive the alarm devices (230) and (232) in the case of LEDs and/or (234) and (236) in the case of audible alarms. The audible alarms may have volume controls (240) and (242).

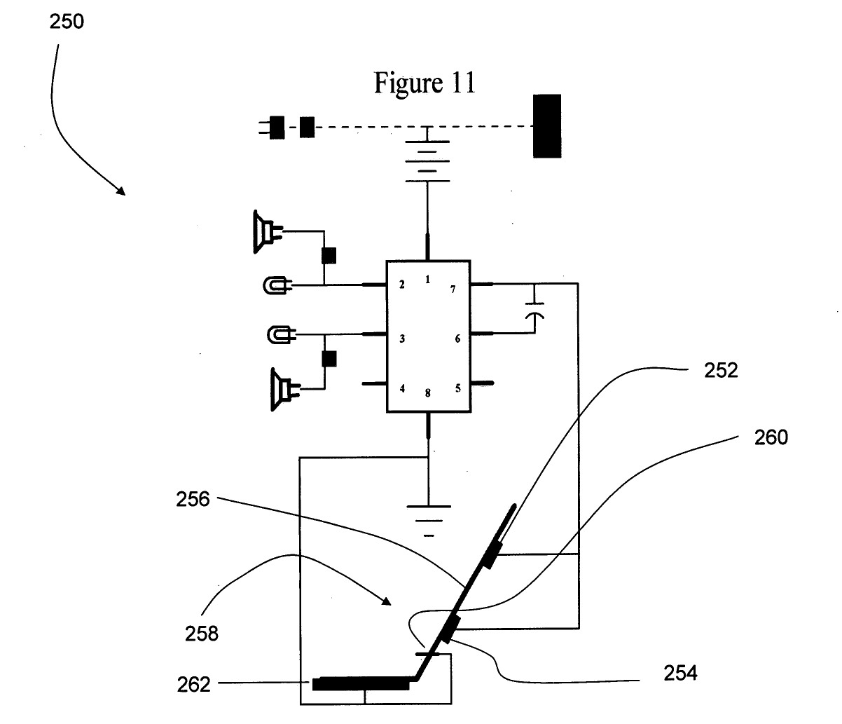

Referring to FIG. 11, there is shown another embodiment of the invention (250) in which the detection probes are replaced by detection strips (252) and (254) adapted to sense the level of water through the wall (256) of a non-conducting receptacle (258). The components of this embodiment are the same as the embodiment shown in FIG. 10, save that the strips (252) and (254) encircle the receptacle. The strips are generally rectangular in cross-section as shown in FIG. 11. Since the receptacle is non-conducting, grounding must be achieved by grounding probe (260) penetrating the side wall (256) of the receptacle and a grounding strip (262) at the bottom of the receptacle.

It is apparent from the foregoing description that the present invention and its embodiments are improvements over the known art combination water container and low water level alarm apparatus in that it relies on a simple low water level detection means couples with inexpensive and readily available integrated circuit technology.

Although this description contains much specificity, these should not be construed as limiting the scope of the invention by merely providing illustrations of some of the embodiments of the invention. Thus the scope of the invention should be determined by the appended claims and their legal equivalents rather than by the examples given.

1. A water container in combination with a water level alerting apparatus comprising:
a. a receptacle for containing a predetermined amount of water, said receptacle having at least one water level alarm trip point located at a predetermined water level in said the receptacle;
b. means for detecting said at least one water level alarm trip point;
c. means for converting said detection of the least one water level alarm trip point into an electronic signal; and,
d. means for converting said electronic signal into a human detectable alarm.

2. The combination as claimed in claim 1, wherein the at least one water level alarm trip point comprises a low water level alarm trip point.

3. The combination as claimed in claim 1, wherein the at least one water level alarm trip point comprises a low water level alarm trip point and a high water level alarm trip point.

4. The device as claimed in claim 3, wherein the receptacle has a bottom and a sidewall surrounding said bottom thereby forming said water container, and wherein said sidewall has a predetermined height and a predetermined thickness, an further wherein said predetermined height is sufficient to allow the container to contain a predetermined volume of water, and wherein the low water level alarm trip point is located a first predetermined distance above said receptacle bottom, and wherein the high water level alarm trip point is located a second predetermined distance above the receptacle bottom.

5. The device as claimed in claim 4, wherein said means for detection of the low water level alarm trip point and the high level alarm trip point comprises a first detecting probe penetrating said sidewall of the receptacle into the container at the low water level alarm trip point and a second detecting probe penetrating the sidewall of the receptacle into the container at the high water level alarm trip point, and further wherein said first detecting probe is normally wet and said second detecting probe is normally dry so that a low water level condition is detected when the first probe transits form a wet condition to a dry condition and a high water level condition is detected when the second probe transits from a dry condition to a wet condition.

6. The device as claimed in claim 5, wherein said first detecting probe and said second detecting probe are conductive probes adapted for detecting aqueous fluids.

7. The device as claimed in claim 6, wherein said conductive probes are metal rods, and wherein the first detecting probe metal rod has a first wet condition and a second dry condition, and wherein the second detecting probe metal rod has a first dry condition and a second wet condition, and further wherein the metal rods are insulated by insulating means from the sidewall of the receptacle, and wherein the conductive probes are adapted to provide a capacitance signal when they change from a first to a second condition.

8. The device as claimed in claim in claim 7, wherein said second dry condition of the first metal rod detecting probe is adapted to occur at the low water level alarm trip point, and wherein said second wet condition of the second metal rod detecting probe is adapted to occur at the high water level alarm trip point.

9. The device as claimed in claim 8, wherein means for converting the detection of the least one water level alarm trip point into an electronic signal comprises an integrated circuit.

10. The device as claimed in claim 9, wherein said integrated circuit comprises:
a. at least two analogue inputs for receiving analogue signals from the conductive probes;
b. an analogue to digital signal converter for receiving said analogue signals and converting them to digital signals
c. an amplifier for amplifying said digital signals; and,
d. at least one digital output for activating said human detectable alarm.

11. The device as claimed in claim 10 further comprising a DC power source.

12. The device as claimed in claim 11 further comprising a capacitor located between the probes and the integrated circuit to prevent DC current flowing to the conductive probes.

13. The device as claimed in claim 12, wherein the integrated circuit is a QT114 Charge Transfer QLevel™ sensor manufactured and sold by QProx™.

14. The device as claimed in claim 13, wherein the human detectable alarm is an audible alarm.

15. The device as claimed in claim 14 wherein said audible alarm has a volume control.

16. The device as claimed in claim 15, wherein the human detectable alarm is a visual alarm.

17. The device as claimed in claim 16, wherein said visual alarm is a light emitting diode.

18. The device as claimed in claim 17, wherein said DC power source is a battery having a predetermined voltage suitable for operating the device.

19. A water container in combination with a water level alerting apparatus comprising:
a. a receptacle for containing a predetermined amount of-water, said receptacle having a sidewall, a low water level alarm trip point and a high water level alarm trip point;
b. a low water detection probe co-located at said low water alarm trip point and a high-water detection probe co-located at said high water alarm trip point, said low water detection probe and said high water level detection probe comprising metal rods penetrating said sidewall;
c. an integrated circuit comprising at least two analogue inputs for receiving analogue signals from the low water detection probe and the high water detection probe, an analogue to digital converter to convert said analogue signals to digital signals; an amplifier to amplify said digital signals, and a human detectable alarm device activated by said amplified digital signals;
d. a capacitor connected between the low water level detection probe, the high water detection probe and the integrated circuit, said capacitor adapted to impede the flow of DC current into the probes; and,
e. a DC battery power source to energize the integrated circuit and said human detectable alarm devices.

20. A water container in combination with a water level alerting apparatus comprising:
a. a receptacle for containing a predetermined amount of water, said receptacle having an exterior sidewall, a low water level alarm trip point and a high water level alarm trip point;
b. a low water detection probe co-located at said low water alarm trip point and a high water detection probe co-located at said high water alarm trip point, said low water detection probe and said high water level detection probe comprise conductive metal strips encircling the exterior sidewall of the receptacle, wherein said metal strips are adapted to detect the water level on the opposite side of the exterior side wall;
c. an integrated circuit comprising at least two analogue inputs for receiving analogue signals from the low water detection probe and the high water detection probe, an analogue to digital converter to convert said analogue signals to digital signals; an amplifier to amplify said digital signals, a human detectable alarm device activated by said amplified digital signals;
d. a capacitor connected between the low water level detection probe, the high water detection probe and the integrated circuit, said capacitor adapted to impede the flow of DC current into the probes; and,
e. a DC battery power source to energize the integrated circuit and said human detectable alarm devices.
